(19) United States
(12) Patent Application Publication
(10) Pub. No.: US 2009/0007785 A1
(43) Pub. Date: Jan. 8, 2009

(54) Method for removing mercury vapor in gas

(76) Inventors: Toshio Kimura, Osaka (JP); Tetsuya Fukunaga, Osaka (JP); Keizo Furukawa, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 12/073,156

(22) Filed: Feb. 29, 2008

(30) Foreign Application Priority Data
Mar. 1, 2007 (JP) 2007-51087

(51) Int. Cl. B01D 53/64; B01D 53/02

(52) U.S. Cl. 95/134

(57) ABSTRACT

When sulfur oxides are present in mercury vapor-containing gas, the adsorption of mercury vapor by activated carbon is inhibited. Therefore, there has been demand for development of a method for effective adsorption removal of mercury vapor even in the coexistence of sulfur oxides.

Efficient and long-term removal of mercury vapor was made successful by contacting an activated carbon adsorbent consisting of 100 parts by weight of activated carbon impregnated with 5 to 70 parts by weight of only an alkali metal halide, with mercury vapor in sulfur oxide-containing gas.

### TECHNICAL FIELD

The present invention relates to a method for effective adsorption and removal of mercury vapor in gas containing both sulfur oxides and mercury vapor.

### BACKGROUND ART

Various gas such as an electrolytic hydrogen gas, natural gas, an incinerator exhaust gas, an exhaust gas from a factory dealing with mercury often contain mercury vapor. Mercury vapor-containing electrolytic hydrogen when used in chemical synthesis may act as a catalyst poison. In addition, mercury vapor in natural gas can erode aluminum parts at pipes and heat exchangers in a liquefaction process of gas to cause a furious accident. Mercury vapor together with sulfur oxides and nitrogen oxides may be contained in an incinerator exhaust gas and an exhaust gas discharged from a coal burning boiler, to cause air pollution and also cause harm to the human body and animals and plants as well.

As activated carbon for removing mercury, which used in gas containing mercury vapor, there are known activated carbon having alkali metal iodides and metal sulfates or nitrates such as those of iron, nickel, copper, zinc etc. supported thereon (Patent Document 1) and activated carbon having sulfur supported thereon (Non-patent Document 1).

[Patent Document 1] JP-A 59-10343

[Non-patent Document 1] Recent Adsorption Technology Handbook, p. 515, Table 3

### DISCLOSURE OF THE INVENTION

The adsorbents described in Patent Document 1 and Reference Document 1 are effective in removing mercury vapor in an electrolytic hydrogen gas, natural gas, and an exhaust gas from a factory dealing with mercury, but have a problem of a reduction in adsorption power in a relatively short time when used in removing mercury vapor in gas discharged from various incinerators such as a garbage incinerator, an industrial waste incinerator and from coal burning boilers used in coal-fired thermal power stations.

For investigating the cause for reduction in power to adsorb mercury vapor in a relatively short time in the above case, the present inventors examined compositions in gases discharged from incinerators and coal burning boilers, and as a result, they found that sulfur oxides such as SO₂ and SO₃ occur at a concentration of 5 to 1000 ppm, particularly 50 to 500 ppm. As a result of further study, the inventors revealed that when sulfur oxides occur in gas, the sulfur oxides are adsorbed selectively into activated carbon to clog pores of the activated carbon thereby reducing the ability thereof to adsorb mercury vapor in a short time.

### Means to Solve the Problem

Accordingly, the present inventors made extensive study to seek a method of efficiently adsorbing mercury vapor even in the presence of sulfur oxides, and as a result, the inventors unexpectedly found that while activated carbon having alkali metal iodides and metal sulfates or nitrates such as those of iron, nickel, copper, zinc etc. supported thereon and activated carbon having sulfur supported thereon, which were conventionally effective in adsorption removal of mercury vapor in gas scarcely containing sulfur oxides, reduce their ability to adsorb mercury vapor in a relatively short time, activated carbon having an alkali metal iodide only supported thereon can be used in adsorption and removal of mercury vapor over a long period. On the basis of this finding, the inventors made further study to complete the present invention.

That is, the present invention relates to:

(1) a method for removing mercury vapor in gas, which comprises contacting an adsorbent consisting of 100 parts by weight of activated carbon impregnated with 5 to 70 parts by weight of only an alkali metal halide, with gas containing mercury vapor and 5 to 1000 ppm sulfur oxides,
(2) the method for removing mercury vapor in gas according to the above-mentioned (1), wherein the alkali metal halide is potassium iodide or sodium iodide,
(3) the method for removing mercury vapor in gas according to the above-mentioned (1) or (2), wherein the adsorbent consisting of 100 parts by weight of activated carbon impregnated with 20 to 70 parts by weight of only an alkali metal halide, and
(4) the method for removing mercury vapor in gas according to the above-mentioned (1) or (2), wherein the adsorbent consisting of 100 parts by weight of activated carbon impregnated with 30 to 70 parts by weight of only an alkali metal halide is contacted at 150° C. or less with gas containing mercury vapor and 50 to 1000 ppm sulfur oxides.

The material of activated carbon that can be used in the present invention may be any one of generally used materials such as wood, sawdust, charcoal, sawdust coal, nut shells such as coconut shell, walnut shell, fruit seeds of a peach, a plum, by-products of pulp production such as lignin waste, plant-based materials such as waste from sugar refining (bagasse), blackstrap molasses, mineral materials such as peat, grass peat, lignite, brown coal, bituminous coal, anthracite, coke, coal tar, petroleum pitch, and synthetic resin materials such as acrylic resin, vinylidene chloride resin, phenol resin. Activated carbon employed in this invention is desirably activated carbon of high water retention. For producing the activated carbon with high water retention, the activated carbon should be sufficient in strength, and therefore the materials with high density such as nut shells, bituminous coal, anthracite etc. are preferable, and coconuts coal, bituminous coal, anthracite are particularly preferable.

The activation method of carbonaceous material is not particularly limited. For example, use is made of activated active carbon such as carbon activated with active gas activators such as water vapor, oxygen, carbon dioxide gas or chemically activated carbon using phosphoric acid, zinc chloride or potassium hydroxide, described on pp. 61 to 69 in “Activated Carbon-Fundamental and Application”, Kodansha (1992), in Japan.

The activated carbon used in the present invention has a BET specific surface area of usually 500 to 2000 m²/g, preferably 700 to 1800 m²/g as determined by a nitrogen adsorption method.

The pore volume of the activated carbon, as determined by a CI method from a nitrogen adsorption isothermal curve at liquid nitrogen temperature, is 0.3 to 2.0 ml/g, preferably 0.5 to 1.8 ml/g, more preferably 0.6 to 1.5 ml/g.

The water retention of the activated carbon is usually 30 to 70%, preferably 40 to 70%.

The activated carbon may have any form such as powder, granules, crushed particles, cylinder, sphere, fiber, honeycomb, among which the activated carbon having the form of crushed particles and honeycomb are preferably used. In the case of the activated carbon having the form of crushed particles, its particle size is not particularly limited, but is usually about 0.1 to 10 mm, preferably about 0.5 to 5 mm.

When the activated carbon having the form of honeycomb is used, the number of cells is not particularly limited, but usually the activated carbon with 50 to 1000 cells/inch², preferably 150 to 500 cells/inch², is used.

The activated carbon having the form of powder may be used after molding with a thermoplastic resin binder. Alternatively, activated carbon may be used in the form of a sheet having it inserted between polyurethane sheets, nonwoven fabrics, nylon meshes or the like.

As the alkali metal halide supported by activated carbon, it is possible to use a metal halide between an alkali metal selected from metal elements of the group Ia in the periodical table and a halogen element selected from iodine, bromine and chlorine, but potassium and sodium halogen compounds are preferable. As specific compounds, potassium iodide, sodium iodide, potassium chloride and potassium bromide are more preferable, and potassium iodide is most preferable.

The amount of the alkali metal halide impregnated in activated carbon is 5 to 70 parts by weight, preferably 20 to 70 parts by weight, more preferably 30 to 70 parts by weight, most preferably 50 to 70 parts by weight, based on 100 parts by weight of activated carbon.

The alkali metal halide is readily soluble in water. The active carbon is sprayed with the aqueous solution of the alkali metal halide or dipped in the solution followed by drying, whereby the activated carbon impregnated with the alkali metal halide, that is, the adsorbent used in the present invention can be prepared. More specifically, an alkali metal halide in an amount to be impregnated in a predetermined amount of activated carbon is weighed out and then dissolved in a suitable amount of water to prepare a solution (usually 1 to 50 wt % aqueous solution, preferably 20 to 50 wt % aqueous solution), and the resulting solution is uniformly blended, by spraying or sprinkling, with activated carbon at normal temperature or under heating at 30 to 50° C., or activated carbon is dipped in the alkali metal halide aqueous solution to allow the alkali metal halide solution to contact sufficiently with the surface or pores of the activated carbon, followed by drying preferably at 80 to 250° C., more preferably 80 to 150° C. and molding thereof if necessary, to give the adsorbent.

When activated carbon is to be impregnated with a large amount of the alkali metal halide, the impregnation process described above is repeated plural times; that is, the activated carbon once impregnated therewith can be again sprayed with an aqueous solution containing the alkali metal halide or dipped in an aqueous solution containing the alkali metal halide, followed by drying of the activated carbon, to give the adsorbent.

When materials other than the alkali metal halide, for example, transition metal sulfates and nitrates such as iron sulfate, copper sulfate, nickel nitrate etc. are further supported, the ability of the resulting adsorbent to adsorb mercury vapor in the coexistence of sulfur oxides is adversely reduced. Accordingly, the adsorbent carrying an alkali metal halide only is used in the present invention.

When the concentration of mercury in mercury vapor-containing gas is 25 μg/m³ or more, measures should usually be taken to remove mercury.

Sulfur oxides coexisting in gas are those referred to usually as “SOx” such as a sulfur dioxide gas (SO₂), a sulfur trioxide gas (SO₃) etc. Coal and petroleum used as a source of heating power will, upon combustion, emit gas containing sulfur dioxides and mercury vapor, depending on the place of their production.

When the emission gas contains sulfur oxides of 5 ppm or more, the ability of activated carbon to remove mercury vapor by adsorption is decreased as the concentration of sulfur oxides is increased.

When the concentration of sulfur oxides in mercury vapor-containing treated gas in the present invention is 5 ppm or more that is the concentration at which the sulfur oxides initiate inhibition of adsorption of mercury vapor, the effect of the present invention is demonstrated; that is, the treated gas in the present invention contains sulfur dioxides usually at a concentration of 5 to 1000 ppm, more effectively 5 to 500 ppm and 50 to 1000, still more effectively 100 to 200 ppm. When sulfur oxides are contained in such a high concentration that the content thereof in gas exceeds 1000 ppm, it is preferable that the concentration of sulfur oxides is reduced with a desulphurization apparatus, or the gas is diluted with sulfur oxide-free air etc. so as to reduce the concentration to 1000 ppm or less.

The concentration of sulfur oxides in treated gas and the proportion of an alkali halide impregnated in activated carbon are related to each other. That is, when the concentration of sulfur oxides is low (for example, 5 ppm or more to less than 50 ppm), the amount of an alkali halide impregnated is 5 to 30 parts by weight, preferably 5 to 20 parts by weight, based on activated carbon, while when the concentration of sulfur oxides is high (for example, 50 ppm or more to 1000 ppm or less), the amount of an alkali halide impregnated is 20 to 70 parts by weight, preferably 30 to 70 parts by weight, more preferably 50 to 70 parts by weight, based on activated carbon. Impregnation of activated carbon with 80 parts by weight or more of an alkali halide is difficult.

When the activated carbon of the present invention has the form of crushed particles, cylinder, sphere, honeycomb, the activated carbon can charged into a packing column and used by passing sulfur oxide- and mercury vapor-containing gas therethrough. In this case, the flow rate of the gas is usually preferably in the range of 0.1 to 0.5 m/s, more preferably in the range of 0.15 to 0.4 m/s. The space velocity (SV) is a degree of 100 to 200,000 hr⁻¹, preferably 1000 to 100,000 hr⁻¹.

In the method for the present invention, the temperature of this gas is regulated in the range of 0 to 150° C., preferably 10 to 80° C. or. The relative humidity of the gas is preferably regulated in the range of 0 to 80%.

Exhaust gas generated from coal burning boilers used in coal-fired thermal power stations etc. contain dusts, nitrogen oxides and sulfur oxides and is thus passed usually through a denitrification apparatus, an electric dust collector, a desulphurization apparatus etc. and discharged from exhaust flue to the air.

When the activated carbon has the form of crushed particles, cylinder and sphere, the activated carbon is used in a fixed bed. In the case of a fixed bed, a method for removing mercury vapor by passing exhaust gas through an adsorption column packed with the activated carbon is taken. When dusts are present in treated gas, the activated carbon will be clogged, and thus the fixed bed is set up usually after an electric dust collector. This adsorbent removes mercury effectively but is not that which removes sulfur oxides, and may thus be placed either before or after a desulphurization apparatus. However, when the concentration of sulfur dioxides is 1000 ppm or more, the adsorbent is placed preferably after a desulphurization apparatus.

When the activated carbon has the form of honeycomb, it is usually used in a fixed bed. The activated carbon in the form of honeycomb is characterized by being hardly clogged due to its honeycomb structure and can thus also be placed before an electric dust collector.

### EFFECT OF THE INVENTION

The method for removing mercury vapor in the coexistence of sulfur oxides according to the present invention has extremely high efficiency of elimination of mercury vapor in gas, and its effect persists for a long time.

### BEST MODE FOR CARRYING OUT THE INVENTION

Hereinafter, the present invention is described in more detail by reference to the Examples, Comparative Examples and Test Examples, but the present invention is not limited thereto.

### EXAMPLE 1

5 g of potassium iodide was dissolved in 40 g of distilled water to prepare an aqueous solution of potassium iodide. 100 g of crushed coconut activated carbon having a specific surface area of 1130 m²/g as determined by a BET method, an average pore diameter of 1.71 nm, a pore volume of 0.482 ml/g, a water retention of 42% and a particle diameter of 0.71 to 1.00 mm was placed in a polypropylene container, then stirred (100 to 300 rpm) in a table mixer and simultaneously impregnated by spraying with the whole of the previously prepared aqueous solution of potassium iodide at 25° C., followed by drying at 110° C., to give an adsorbent consisting of potassium iodide-supported activated carbon.

### EXAMPLE 2

10 g of potassium iodide was dissolved in 40 g of distilled water to prepare an aqueous solution of potassium iodide. 100 g of the crushed coconut activated carbon used in Example 1 was placed in a polypropylene container, then stirred (100 to 300 rpm) in a table mixer and simultaneously sprayed with the whole of the previously prepared aqueous solution of potassium iodide, followed by drying at 110° C., to give an adsorbent consisting of potassium iodide-supported activated carbon.

### EXAMPLE 3

20 g of potassium iodide was dissolved in 40 g of distilled water to prepare an aqueous solution of potassium iodide. 100 g of the crushed coconut activated carbon used in Example 1 was placed in a polypropylene container, then stirred (100 to 300 rpm) in a table mixer and simultaneously sprayed with the whole of the previously prepared aqueous solution of potassium iodide, followed by drying at 110° C., to give an adsorbent consisting of potassium iodide-supported activated carbon.

### EXAMPLE 4

30 g of potassium iodide was dissolved in 40 g of distilled water to prepare an aqueous solution of potassium iodide. 100 g of the crushed coconut activated carbon used in Example 1 was placed in a polypropylene container, then stirred (100 to 300 rpm) in a table mixer and simultaneously sprayed with the whole of the previously prepared aqueous solution of potassium iodide, followed by drying at 110° C., to give an adsorbent consisting of potassium iodide-supported activated carbon.

### EXAMPLE 5

50 g of potassium iodide was dissolved in 50 g of distilled water to prepare an aqueous solution of potassium iodide. 100 g of the crushed coconut activated carbon used in Example 1 was placed in a polypropylene container, then stirred (100 to 300 rpm) in a table mixer and simultaneously sprayed with the whole of the previously prepared aqueous solution of potassium iodide, followed by drying at 110° C., to give an adsorbent consisting of potassium iodide-supported activated carbon.

### EXAMPLE 6

70 g of potassium iodide was dissolved in 70 g of distilled water to prepare an aqueous solution of potassium iodide. 100 g of the crushed coconut activated carbon used in Example 1 was placed in a polypropylene container, then stirred (100 to 300 rpm) in a table mixer and simultaneously sprayed with half of the previously prepared aqueous solution of potassium iodide, then dried at 110° C., sprayed with other half of the aqueous solution of potassium iodide and then dried at 110° C., to give an adsorbent consisting of potassium iodide-supported activated carbon.

### COMPARATIVE EXAMPLE 1

1.0 g of potassium iodide was dissolved in 40 g of distilled water to prepare an aqueous solution of potassium iodide. 100 g of the crushed coconut activated carbon used in Example 1 was placed in a polypropylene container, then stirred (100 to 300 rpm) in a table mixer and simultaneously sprayed with the whole of the previously prepared aqueous solution of potassium iodide, followed by drying at 110° C., to give an adsorbent consisting of potassium iodide-supported activated carbon.

### COMPARATIVE EXAMPLE 2

10 g of potassium iodide and 10 g (anhydride equivalence) of iron sulfate were dissolved in 40 g of distilled water to prepare an aqueous solution of potassium iodide-iron sulfate. 100 g of the crushed coconut activated carbon used in Example 1 was placed in a polypropylene container, then stirred (100 to 300 rpm) in a table mixer and simultaneously sprayed with the whole of the previously prepared aqueous solution of potassium iodide-iron sulfate, followed by drying at 110° C., to give an adsorbent consisting of potassium iodide-iron sulfate-supported activated carbon.

### COMPARATIVE EXAMPLE 3

10 g of potassium iodide and 10 g (anhydride equivalence) of iron sulfate were dissolved in 30 g of distilled water to prepare an aqueous solution of potassium iodide-iron sulfate. 10 g of sulfur was suspended in 10 g of distilled water to prepare a sulfur suspension. 100 g of the crushed coconut activated carbon used in Example 1 was placed in a polypropylene container, then stirred (100 to 300 rpm) in a table mixer and simultaneously sprayed with the whole of the previously prepared aqueous solution of potassium iodide-iron sulfate and then sprayed with the whole of the previously prepared sulfur suspension, followed by drying at 110° C., to give an adsorbent consisting of sulfur-potassium iodide-iron sulfate-supported activated carbon.

### COMPARATIVE EXAMPLE 4

10 g of sulfur was suspended in 10 g of distilled water to prepare a sulfur suspension. 100 g of the crushed coconut activated carbon used in Example 1 was placed in a polypropylene container, then stirred (100 to 300 rpm) in a table mixer and simultaneously sprayed with the whole of the previously prepared sulfur suspension, followed by drying at 110° C., to give an adsorbent consisting of sulfur-supported activated carbon.

### COMPARATIVE EXAMPLE 5

80 g of potassium iodide was dissolved in 80 g of distilled water to prepare an aqueous solution of potassium iodide. 100 g of the crushed coconut activated carbon used in Example 1 was placed in a polypropylene container, then stirred (100 to 300 rpm) in a table mixer and simultaneously sprayed with half of the previously prepared aqueous solution of potassium iodide and then dried at 110° C. When the activated carbon was thereafter sprayed with other half of the aqueous solution of potassium iodide, the surface of the activated carbon came to be in a state wetted with the aqueous solution without adsorbing the other half of the aqueous solution, and upon drying at 110° C., crystals of potassium iodide were precipitated on the surface of the activated carbon. 100 parts of the activated carbon could not be impregnated with 80 parts of potassium iodide.

### TEST EXAMPLE 1

### Mercury Vapor Adsorption Test with 5 ppm of SO₂, RH=70%

An adsorptive performance measuring apparatus shown in FIG. 1 was installed in a thermostat bath kept at 25° C., and a glass column of 15.6 mm in inner diameter was packed with 3.8 ml of each adsorbent.

In the above sample-packed column, a gas containing mercury vapor at a concentration of 5 mg/m³ and 5 ppm of SO₂ under 70% relative humidity was passed at a flow rate of 2.3 L/min. at a linear velocity of 20 cm/sec. and measured for the concentration of mercury vapor at the outlet relative to the concentration of mercury vapor at the inlet. The concentration of mercury vapor was measured with mercury detector tube No. 40 manufactured by GASTEC CORPORATION.

The 5% breakthrough time (the time elapsed until the ratio of the concentration of mercury vapor after treatment to the concentration of mercury vapor before treatment, that is, the time elapsed until the concentration of leaked mercury vapor reached 5% of the concentration at the inlet) of each adsorbent from the obtained results is shown in Table 1.

The adsorbents in Examples 1 to 6 resulted in maintaining adsorptive performance for a longer time than the adsorbents in Comparative Examples 1 to 4. Particularly the adsorbent in Examples 2 and 3 showed performance that was 9 times or more than that of the adsorbents in Comparative Examples 2 to 3.

### TEST EXAMPLE 2

### Mercury Vapor Adsorption Test with 50 ppm of SO₂, RH=70%

Using the same apparatus as in Test Example 1, a gas containing mercury vapor at a concentration of 5 mg/m³ and 50 ppm of SO₂ under 70% relative humidity was passed at a flow rate of 2.3 L/min. at a linear velocity of 20 cm/sec. and measured for the concentration of mercury vapor at the outlet relative to the concentration of mercury vapor at the inlet. The method for measuring the concentration of mercury vapor was the same as in Test Example 1. The 5% breakthrough time of each adsorbent from the obtained results is shown in Table 1.

The adsorbents in Examples 1 to 6 resulted in maintaining adsorptive performance for a longer time than the adsorbents in Comparative Examples 1 to 4. Particularly the adsorbents in Examples 4 and 5 showed performance that was 10 times or more than that of the adsorbents in Comparative Examples 2 to 3.

### TEST EXAMPLE 3

### Mercury Vapor Adsorption Test with 100 ppm of SO₂, RH=70%)

Using the same apparatus as in Test Example 1, a gas containing mercury vapor at a concentration of 5 mg/m³ and 100 ppm of SO₂ under 70% relative humidity was passed at a flow rate of 2.3 L/min. at a linear velocity of 20 cm/sec. and measured for the concentration of mercury vapor at the outlet relative to the concentration of mercury vapor at the inlet. The method for measuring the concentration of mercury vapor was the same as in Test Example 1. The 5% breakthrough time of each adsorbent from the obtained results is shown in Table 1.

The adsorbents in Examples 1 to 6 resulted in maintaining adsorptive performance for a longer time than the adsorbents in Comparative Examples 1 to 4. Particularly the adsorbents in Examples 5 and 6 showed performance that was 20 times or more than that of the adsorbents in Comparative Examples 2 to 3.

### TEST EXAMPLE 4

### Mercury Vapor Adsorption Test with 200 ppm of SO₂, RH=70%)

Using the same apparatus as in Test Example 1, a gas containing mercury vapor at a concentration of 5 mg/m³ and 200 ppm of SO₂ under 70% relative humidity was passed at a flow rate of 2.3 L/min. at a linear velocity of 20 cm/sec. and measured for the concentration of mercury vapor at the outlet relative to the concentration of mercury vapor at the inlet. The method for measuring the concentration of mercury vapor was the same as in Test Example 1. The 5% breakthrough time of each adsorbent from the obtained results is shown in Table 1.

The adsorbents in Examples 1 to 6 resulted in maintaining adsorptive performance for a longer time than the adsorbents in Comparative Examples 1 to 4. Particularly the adsorbents in Examples 5 and 6 showed performance that was 50 times or more than that of the adsorbents in Comparative Examples 2 to 3.

### TEST EXAMPLE 5

### Mercury Vapor Adsorption Test with 500 ppm of SO₂, RH=70%)

Using the same apparatus as in Test Example 1, a gas containing mercury vapor at a concentration of 5 mg/m³ and 500 ppm of SO₂ under 70% relative humidity was passed at a flow rate of 2.3 L/min. at a linear velocity of 20 cm/sec. and measured for the concentration of mercury vapor at the outlet relative to the concentration of mercury vapor at the inlet. The method for measuring the concentration of mercury vapor was the same as in Test Example 1. The 5% breakthrough time of each adsorbent from the obtained results is shown in Table 1.

The adsorbents in Examples 1 to 6 resulted in maintaining adsorptive performance for a longer time than the adsorbents in Comparative Examples 1 to 4. Particularly the adsorbents in Examples 5 and 6 showed performance that was 20 times or more than that of the adsorbents in Comparative Examples 2 to 3.

### TEST EXAMPLE 6

### Mercury Vapor Adsorption Test with 1000 ppm of SO₂, RH=70%)

Using the same apparatus as in Test Example 1, a gas containing mercury vapor at a concentration of 5 mg/m³ and 1000 ppm of SO₂ under 70% relative humidity was passed at a flow rate of 2.3 L/min. at a linear velocity of 20 cm/sec. and measured for the concentration of mercury vapor at the outlet relative to the concentration of mercury vapor at the inlet. The method for measuring the concentration of mercury vapor was the same as in Test Example 1. The 5% breakthrough time of each adsorbent from the obtained results is shown in Table 1.

The adsorbents in Examples 1 to 6 resulted in maintaining adsorptive performance for a longer time than the adsorbents in Comparative Examples 1 to 4. Particularly the adsorbents in Examples 4 and 5 showed performance that was 30 times or more than that of the adsorbents in Comparative Examples 2 to 3.

### TEST EXAMPLE 7

### Mercury Vapor Adsorption Test with 0 ppm of SO₂, RH=30%)

Using the same apparatus as in Test Example 1, a (SO₂-free) gas containing mercury vapor at a concentration of 5 mg/m³ under 30% relative humidity was passed at a flow rate of 2.3 L/min. at a linear velocity of 20 cm/sec. and measured for the concentration of each gas at the outlet relative to the concentration of each gas at the inlet. The method for measuring the concentration of mercury vapor was the same as in Test Example 1. The 5% breakthrough time of each adsorbent from the obtained results is shown in Table 1.

In the system where no sulfur oxide was coexist, the adsorbents in Examples 3 to 6 resulted in maintaining adsorptive performance for a longer time than the adsorbents in Comparative Examples 1 to 4, and the adsorptive performance of the adsorbent in Example 1 and 2 was superior to that of the adsorbents in Comparative Examples 1 and 4, but was less than that of the adsorbent in Comparative Example 2, so the result did not always show excellent adsorption characteristic.

### SUMMARY OF THE RESULTS IN THE TEST EXAMPLES

As shown in Test Example 7, the adsorbent impregnated with 5 to 70 parts of potassium iodide, in the system where sulfur dioxide was not coexistent in a treated gas, was such at a level as not to be said to be superior in mercury removal performance to the other activated carbon. In the system where sulfur dioxide was coexistent in a treated gas, such as in Test Examples 1 and 2, the activated carbon impregnated with 5 to 70 parts of potassium iodide, as compared with the other activated carbon, showed unexpectedly excellent mercury removal performance.

Particularly in the system where sulfur oxide was coexistent at a high concentration of 50 to 1000 ppm, the adsorbent impregnated with 20 to 70 parts of potassium iodide, as compared with the other adsorbents, showed extremely excellent mercury removal performance.

As the concentration of sulfur oxide was increased, the adsorptive performance of the adsorbents in Comparative Examples 2 to 4 was reduced to 1/24 at the maximum or less, while the reduction in the adsorptive performance of the adsorbents in the Examples was about ⅙ at the maximum, and some of the adsorbents showed improvement in mercury vapor adsorptive performance. The adsorbent with less impregnated iodine in Comparative Example 1 didn't show reduction in adsorptive performance, but was still not practical because of its lower removal ability than that of the adsorbents in the other Comparative Examples and the Examples.

TABLE 1

| | | Adsorbent | | | | 5% Breakthrough Time (hr) | | | | | | |
|---|---|---|---|---|---|---|---|---|---|---|---|---|
| | | Activated | | | | Test Examples | | | | | | |
| | | Carbon | KI | FeSO₄ | S | 7 | 1 | 2 | 3 | 4 | 5 | 6 |
| SO₂ concentration | | | | | | 0 | 5 | 50 | 100 | 200 | 500 | 1000 |
| (ppm) | | | | | | | | | | | | |
| Examples | 1 | 100 | 5 | — | — | 45 | 120 | 28 | 23 | 7.6 | 12 | 12 |
| | 2 | 100 | 10 | — | — | 80 | 720 | 60 | 31 | 14 | 15 | 43 |
| | 3 | 100 | 20 | — | — | 120 | 650 | 75 | 65 | 60 | 75 | 90 |
| | 4 | 100 | 30 | — | — | 150 | 93 | 130 | 98 | 110 | 108 | 180 |
| | 5 | 100 | 50 | — | — | 440 | 75 | 260 | 300 | 360 | 230 | 155 |
| | 6 | 100 | 70 | — | — | 100 | 80 | 110 | 320 | 450 | 170 | 105 |
| Comparative | 1 | 100 | 1 | — | — | 3.0 | 5.5 | 11 | 4.5 | 6.0 | 4.0 | 4.1 |
| Examples | 2 | 100 | 10 | 10 | — | 94 | 68 | 12 | 15 | 6.0 | 8.0 | 5.0 |
| | 3 | 100 | 10 | 10 | 10 | 68 | 62 | 9.4 | 14 | 4.8 | 7.5 | 2.8 |
| | 4 | 100 | — | — | 10 | 38 | 35 | 5.0 | 8 | 3.0 | 4.5 | 2.5 |

### INDUSTRIAL APPLICABILITY

In removal of mercury vapor in a gas where 5 to 1000 ppm sulfur oxides are coexistent, the gas is contacted with activated carbon impregnated with only an alkali metal halide in an amount of 5 to 70% by weight based on activated carbon according to the present invention, whereby mercury vapor can be efficiently removed by adsorption, and therefore, mercury vapor in sulfur oxide-containing exhaust gas generated from sulfur-containing coal burning boilers used in coal-fired thermal power stations etc. can be removed by adsorption for a long period of time.

### BRIEF DESCRIPTION OF THE DRAWING

FIG. 1 Schematic diagram of an apparatus for testing of mercury vapor removal

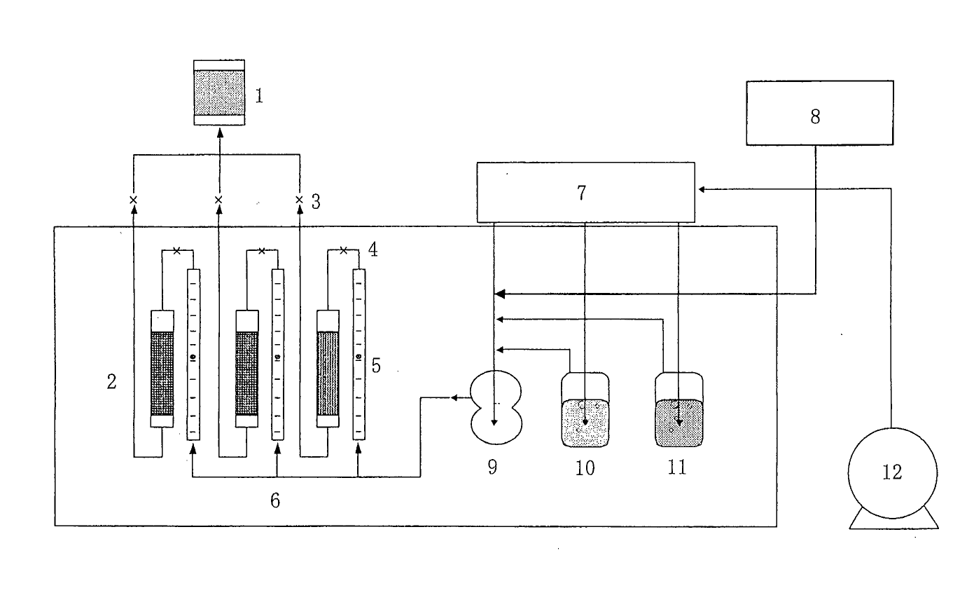

### EXPLANATION OF NUMERALS

1: Discharged mercury eliminating column
2: Sample column
3: Outlet
4: Inlet
5: Flow meter
6: Thermostat bath at 25° C.
7: Mass flow controller (dry air supply)
8: SO₂ cylinder
9: Gas mixing bottle
10: Mercury vapor generator
11: Steam generator
12: Compressor

1. A method for removing mercury vapor in gas, which comprises contacting an adsorbent consisting of 100 parts by weight of activated carbon impregnated with 5 to 70 parts by weight of only an alkali metal halide, with gas containing mercury vapor and 5 to 1000 ppm sulfur oxides.

2. The method for removing mercury vapor in gas according to claim 1, wherein the alkali metal halide is potassium iodide or sodium iodide.

3. The method for removing mercury vapor in gas according to claim 1, wherein the adsorbent consisting of 100 parts by weight of activated carbon impregnated with 20 to 70 parts by weight of only an alkali metal halide.

4. The method for removing mercury vapor in gas according to claim 1, wherein the adsorbent consisting of 100 parts by weight of activated carbon impregnated with 30 to 70 parts by weight of only an alkali metal halide is contacted at 150° C. or less with gas containing mercury vapor and 50 to 1000 ppm sulfur oxides.

5. The method for removing mercury vapor in gas according to claim 2, wherein the adsorbent consisting of 100 parts by weight of activated carbon impregnated with 20 to 70 parts by weight of only an alkali metal halide.

6. The method for removing mercury vapor in gas according to claim 2, wherein the adsorbent consisting of 100 parts by weight of activated carbon impregnated with 30 to 70 parts by weight of only an alkali metal halide is contacted at 150° C. or less with gas containing mercury vapor and 50 to 1000 ppm sulfur oxides.
